(19) United States
(12) Patent Application Publication
(10) Pub. No.: US 2016/0048307 A1
(43) Pub. Date: Feb. 18, 2016

(54) SYSTEMS AND METHODS DYNAMIC LOCALIZATION OF A CLIENT DEVICE

(71) Applicant: Zynga Inc., San Francisco, CA (US)

(72) Inventors: Mark Troyer, Belmont, CA (US); Benjamin Cooley, San Francisco, CA (US); Luke Rajlich, San Francisco, CA (US); Mohamed Ali Kilani, Palo Alto, CA (US)

(21) Appl. No.: 14/883,365

(22) Filed: Oct. 14, 2015

Related U.S. Application Data
(63) Continuation of application No. 13/624,441, filed on Sep. 21, 2012.
(60) Provisional application No. 61/538,408, filed on Sep. 23, 2011.

(51) Int. Cl. G06F 3/0484

(52) U.S. Cl. CPC G06F 3/04845

(57) ABSTRACT

Various techniques for dynamic localization of a client device are disclosed. In an example embodiment, a geographic location associated with a client device is determined, along with a localized language requirement associated with a geographic location. When content is received at the client device for presentation on a display, a set of definitions defining elements of a user interface are accessed. The definitions are used to resize elements to be displayed based on the content and the localized language requirement. Various additional embodiments access definitions and manage the dynamic localization in different ways.

### CLAIM OF PRIORITY

The present application is a continuation of U.S. patent application Ser. No. 13/624,441, filed on Sep. 21, 2012, which claims the benefit of U.S. Provisional Patent Application Ser. No. 61/538,408, filed on Sep. 23, 2011, which applications are incorporated by reference herein in their entirety.

### TECHNICAL FIELD

The present disclosure relates to dynamic device configuration based on a device location. In an example embodiment, various techniques for dynamically displaying and changing elements for user interaction with a device based on a device location are presented.

### BACKGROUND

Variable-sized content is often displayed in graphical user interfaces. For example, localization text that is displayed to multi-language users inside of GUIs often varies in dimension, as certain languages may require more or less characters and display area for text within the GUI. This adds complexities to the implementation of variable-sized content displays in many user interfaces, which are commonly created in a static fashion with fixed dimensions or sizes. Thus, a user interface display often must be created to render each possible variation of the variable-sized content (often to the largest possible result), and extensive testing needs to be performed on the user interface to ensure that the variable-sized content renders correctly with all combinations of content display. Techniques are needed to provide user interfaces that dynamically adapt to variable-sized content and display requirements.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system for implementing various example embodiments;

FIG. 2 is a schematic diagram showing an example of a social network within a social graph, according to some embodiments;

FIG. 3 is a block diagram showing example components of a system used in connection with generating and rendering a dynamic user interface display, in accordance with various example embodiments;

FIG. 4 is an interface diagram illustrating an example user interface layout of elements in a dynamic user interface display generated according to some embodiments;

FIG. 5 is an interface diagram illustrating an example hierarchy of elements in a dynamic user interface display generated according to some embodiments;

FIG. 6 is a flowchart showing an example method of defining a design of a dynamic user interface display, according to some embodiments;

FIG. 7 is a flowchart showing an example method of rendering a design of a dynamic user interface display, according to some embodiments;

FIG. 8 is a flowchart showing an example method of parsing definitions to render a design of a dynamic user interface display, according to some embodiments;

FIG. 9 is a block diagram illustrating an example database to store information related to dynamic user interface displays, according to some embodiments;

FIG. 10 is a diagrammatic representation of an example data flow between example components of the example system of FIG. 1, according to some embodiments;

FIG. 11 is a schematic diagram showing an example network environment, in which various example embodiments may operate, according to some embodiments; and

FIG. 12 is a block diagram illustrating an example computing system architecture, which may be used to implement one or more of the methodologies described herein, according to some embodiments.

### DESCRIPTION OF EXAMPLE EMBODIMENTS

Various example embodiments disclosed herein provide techniques and configurations used in user interfaces, including enhancements for data- or content-driven dynamic user interface displays. In one example embodiment, a series of display definitions provided by an interface description language in an XML (eXtensible Markup Language) or JSON (JavaScript Object Notation) format may be created and parsed to dynamically render elements such as dialogs, panels, windows, and other visual displays rendered in a graphical user interface, such as in an ActionScript-enabled Flash object. The dynamic content displays disclosed herein may be configured to automatically resize to content, automatically reposition to accommodate localization text and graphics, apply styles and other display definitions, represent complex user interface configurations using an interface description language, and the like.

Other example embodiments disclosed herein include the use of a dynamic layout engine to parse and generate displays from the interface description language display definitions, tools to generate, test, and render the interface description language display definitions, referential rendering techniques to allow the display of referenced content, recursive embedding techniques to embed content in dynamically-displayed content with external references, integration of dynamically-rendered content with a content management system, integration of the dynamically-rendered content with localization techniques, integration of the dynamically-rendered content with back-end data services and application programming interfaces (APIs), and the like.

Various example embodiments may be applicable to the display of a visible user interface component known as a dialog. As used herein, the term “dialog” may refer to any number of user interface display elements and configurations, including panels, windows, pop-ups, or frames, and does not necessarily require the display of text or images, or user interaction. For example, a dialog displayed in a user interface may or may not provide an input for user textual input, provide one or more selectable options to receive interaction from a user, and actively display for a permanent or temporal duration of time.

In an example embodiment, dialogs and other user interface displays are loaded from interface description language data that describes the contents of the user interface display through a nested tree of views. The layout of the display is determined by the sizes and relative positions of the views in the view tree, rather than through absolute positioning in the user interface with X, Y coordinates or absolute width and height values.

A dynamic layout engine or other rendering component may be configured to parse this interface description language data and automatically calculate the layout of the user interface display. For example, the specific size of a displayed dialog may be determined by calculating the size needed to contain the children of each element of the dialog, based on the content to be displayed in each element. This is particularly useful when the content to be displayed is a list of items, or the content includes varying amounts of localized text or data-dependent graphics.

The dynamic layout engine may also provide auto-sizing while accounting for multiple content fields that may need to be resized within a control, nested controls being contained within each other, and display layouts of any complexity. With use of the dynamic dialog techniques described herein, the size assigned to a display field such as a text field may be the size of the width and height of the text it contains, and the rest of the dialog may be automatically scaled larger to accommodate that text field and all of the rest of the text fields and component included in the visible portion of the dialog. For example, if the text field is being displayed in an East-Asian font, the entire dialog may need to be 30% larger than a European-language dialog. The dimensions for the dialog may be computed automatically through the text field's containers margins, padding, maximum and minimum widths and heights, and the like.

Use of the automatic layout system also allows user interface displays to be created that automatically align to the left, right, top, or bottom of the screen. Likewise, these techniques also enable user interface displays that automatically scale themselves based on the number of sub-panels and nested content.

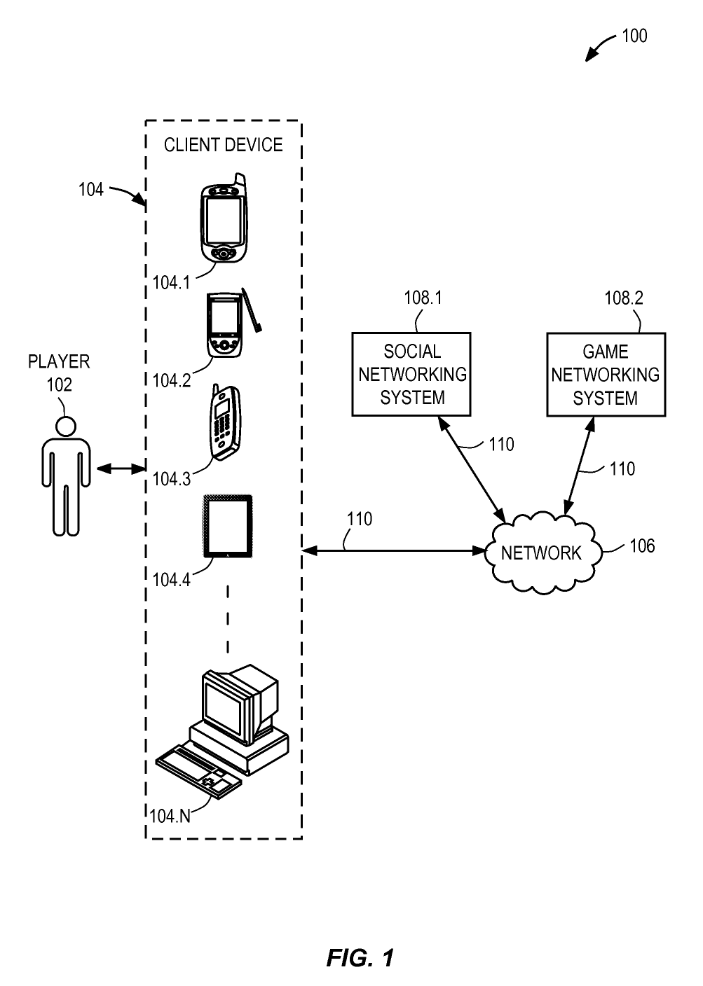

FIG. 1 is a schematic diagram showing an example of a system 100 for implementing various example embodiments described herewith. In some embodiments, the system 100 comprises a player 102, a client device 104, a network 106, a social networking system 108.1, a game networking system 108.2. The components of the system 100 may be connected directly or over the network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant (PDA) 104.2, a mobile phone 104.3, a personal computer 104.n, a laptop, a computing tablet, and the like. The client device 104 may access the social networking system 108.1 or the game networking system 108.2 directly, via the network 106, or via a third-party system. For example, the client device 104 may access the game networking system 108.2 via the social networking system 108.1. The player 102 can use the client device 104 to play the virtual game, within the user interface for the game.

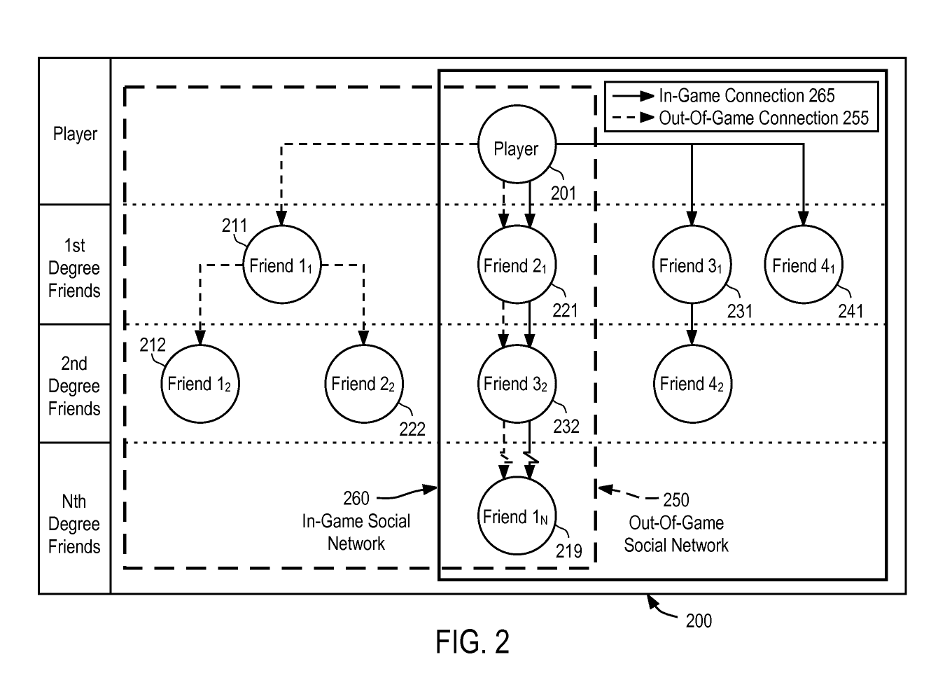

The social networking system 108.1 may include a network-addressable computing system that can host one or more social graphs (see for example FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online games provided in Flash interactive displays. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2.

Although FIG. 1 illustrates a particular example of the arrangement of the player 102, the client device 104, the social networking system 108.1, the game networking system 108.2, and the network 106, this disclosure includes any suitable arrangement or configuration of the these components of system 100.

FIG. 2 is a schematic diagram showing an example of a social network within a social graph 200. The social graph 200 is shown by way of example to include an out-of-game social network 250, and an in-game social network 260. Moreover, in-game social network 260 may include one or more players that are friends with Player 201 (e.g., Friend 231), and may include one or more other players that are not friends with Player 201. The social graph 200 may correspond to the various players associated with one or more virtual games. In an example embodiment, each player may communicate with other players.

The Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.1.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network is formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

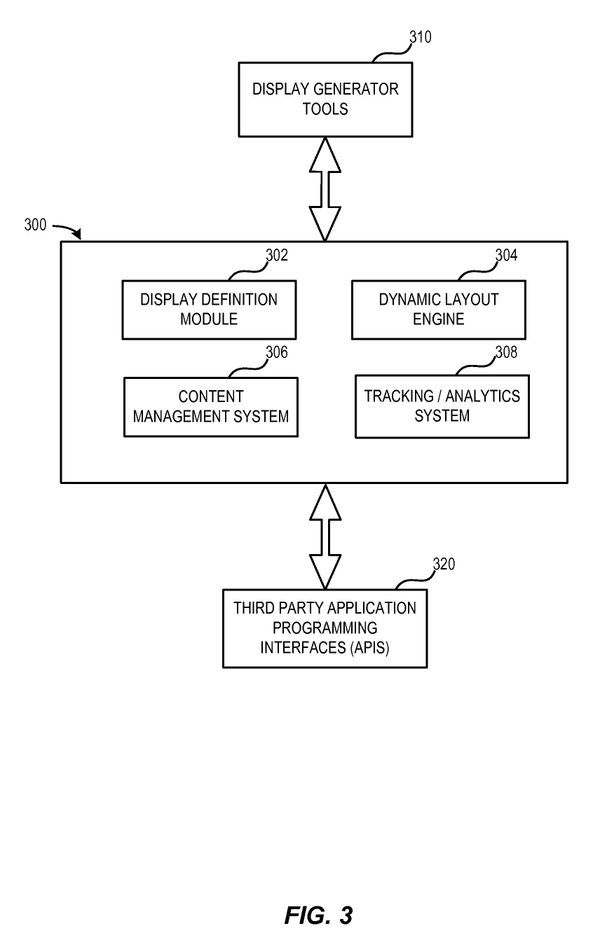

FIG. 3 is a block diagram showing example hardware-implemented components of a system 300 used in connection with generating and rendering a dynamic user interface display. The system 300 may include a display definition module 302 for establishing display definitions of one or more user interfaces, a dynamic layout engine 304 for parsing the display definitions of one or more user interfaces, a content management system 306 for providing content for display in the one or more user interfaces, and a tracking and analytics system 308 for measuring and receiving feedback in connection with user interactions with the one or more user interfaces. Further, the system 300 may be configured to communicate and operably function with one or more display generator tools 310 to generate the display definitions in connection with the display definition module 302, or the content in connection with the content management system 306. The system 300 may be also configured to communicate and operably function with one or more third party application programming interfaces (APIs) 320 which are external to the system 300, in connection with operation of the dynamic layout engine 304, dynamic layout engine 304, or tracking and analytics system 308.

In some example embodiments, modules 302-310 may be implemented using one or more application-specific integrated circuit components, microprocessors, graphics processing units (GPUs), field-programmable gate arrays (FPGAs), or any combination thereof. In other embodiments, system 300 may include a server-side computing device and/or a client side computing device, and modules 302-310 may include executable code that is stored within a computer-readable storage medium of system 300 and executed by a processing unit of system 300. Further, additional characteristics of the various modules 302-310 may also include any of the display definition, and dynamic layout, content management, and tracking/analytics techniques and configurations previously referenced herein.

In one example embodiment, the dynamic dialogs are displayed in one or more interactive Flash display scenarios, and specifically a virtual game provided in connection with the Flash display scenario. The virtual game, for example, may include a virtual environment that may resemble city, a farm, a café, or the like. A player may advance in the virtual game by placing virtual objects on a virtual landscape of the virtual game (e.g., a virtual city). Various dialogs, display panels, text, and graphics may be rendered to the player in the Flash display scenario to advance game play.

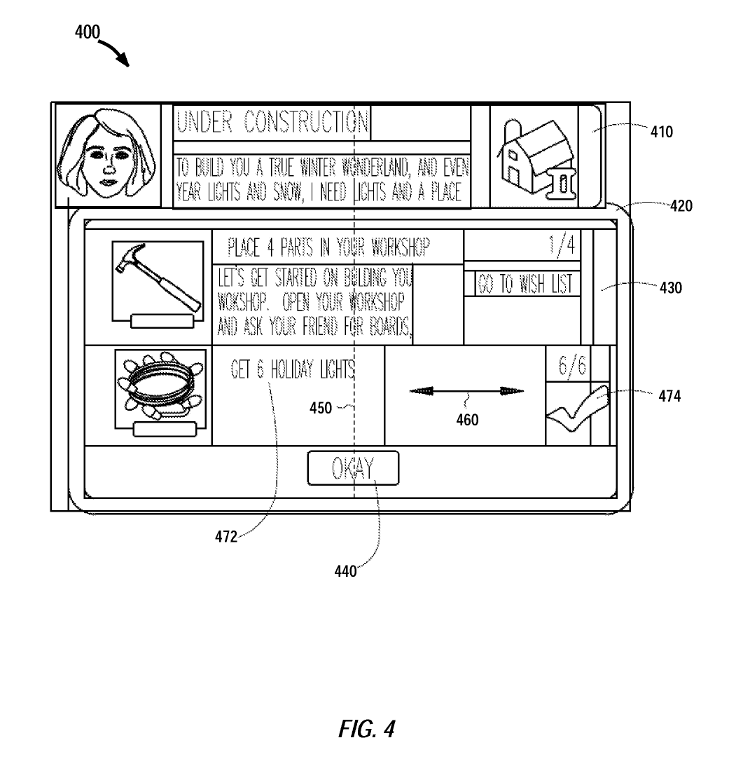

FIG. 4 is an interface diagram illustrating an example user interface layout of elements in a dynamic user interface. As illustrated, dialog 400 provides a display of both graphical and textual information, including a series of framed panels 410, 420, and 430 each including various text and graphics, and with portions of the panels nested over each other in view (as shown, panel 410 partially overlapping panel 420, and panel 430 entirely overlapping and centered on panel 420). Panel 430 further includes a dialog button 440 entirely overlapping the panel 430.

Various elements displayed in the dialog 400 may be configured to be positioned according to various points and references, for example, being aligned along a center vertical axis 450. Thus, the dialog button 440 is illustrated as being horizontally centered to the vertical axis 450. Other images or text likewise may be centered, aligned, or positioned within the dialog display according to a known axis or reference point.

The dynamic spacing that exists between elements of the dynamic dialog is illustrated in horizontal spacing 460. As would be understood, the size of the horizontal spacing 460 may expand or shrink based on the particular images and text located to the right and to the left of the horizontal spacing 460. For example, the text “Get 6 Holiday Lights” 472 may require additional characters to be fully displayed in another language, which may result in horizontal spacing 460 to be reduced. Likewise, the dimensions of checkbox image 474 may differ based on the result of a condition (e.g., whether the task has been completed (with a “checked” image display) or not completed (with a “X” image display)), localization settings, and other like settings.

In one example embodiment, dialogs may be constructed using text within XML-based definitions, allowing controls to be designed and re-arranged by manipulating text such as through cutting and pasting. This enables programmers and designers to easily inspect buttons, lists, and other controls in a dialog, thus making it easier to modify dialogs and panels that are displayed in a binary or proprietary user interface. The textual definitions are then imported into a display in conjunction with a definition-parsing engine, such as a display engine configured for rendering graphical displays within a Flash display object.

For example, a Flash display object may be configured to launch an instance of the definition-parsing engine and read in the specific XML-based definitions. Thus, an XML-based definition may be imported into the Flash display object in conjunction with instantiating a flash-enabled definition-parsing engine. Programmers are may not be required to open the .FLA editable Flash content file to design or edit desired resizable content displays, but may simply edit the XML-based definitions.

The use of text and XML-based definitions also enables a Flash display object to create common styles and reusable components such as window frames, standard button styles, and other themed elements in one place, and reuse them across multiple panels in a flash object. Likewise, the XML-based definitions may be imported into multiple flash objects from a single location or repository, thus effecting consistent styles across multiple user interface displays.

Providing auto-layout functionality within the logic of the definition-parsing engine means that if or when common themed frames or other elements change, all dialogs and display panels that use the elements may automatically adjust to the new sizes. For example, if the XML definition of a standard “OK” button is changed to increase its size, all dialogs that provide references to the “OK” button will automatically resize to accommodate the new button size.

The dynamic-driven techniques described herein may be integrated into a variety of user interface displays, although the following example embodiments are described with specific reference to use of Adobe Flash technology. Additionally, the user interface definition language may be integrated into any number of interactive and multimedia content displays, and may be configured to automatically integrate with features provided by content display native localization, decompression, and asset management services, such as those provided as native functions with Flash.

### Dynamic UI Display Definitions

The following describes a two-part framework that enables dynamic UI displays such as dialogs to redraw or resize based on the content contained within the display. This framework includes the use of dialog display definitions (e.g., XML-format definitions) and a definition-parsing engine. Providing definitions to define elements within the UI displays enables, among other things, dialogs and other windows to scale or stretch uniformly, styles to be applied to various content elements, and content to be organized and fit in an aesthetically pleasing fashion.

In one example embodiment, definitions are defined with use of two types of elements: visual elements that may not have any specific behavior, and controller elements that may define a behavior (e.g., resizing behavior or display behavior) of the visual elements. Separating visual elements from controller elements provides a significant advantage in that visual elements can be standardized across multiple display interfaces, while controller elements can be designed to implement specific display behaviors independent of the text or the graphical content that will ultimately be displayed.

One example of a controller element might include a positioning controller that lays out content in a display interface relative to other items in the context. Another example may include a resize controller, which resizes elements of an interface based on the number of “children objects” presented inside each element. In a Flash-based example, children objects include the drawable items based on a hierarchy, e.g., circles in an object. Because the controller element is separated from the visual elements, a checkbox, for example, is not limited to just a form-based checkbox; rather, a checkbox can be made from any shape, so when a user clicks on it, it toggles any image, shape, or behavior.

In one example embodiment, the style, view, and dialog definitions for dynamic UI displays are stored in hierarchical, text-based dialog resource data definitions (e.g., in an XML formatted-file). A dialog resource XML file can be included in a Flash project, for example, by either by embedding it in the .swf Flash file, or by loading it from a web server using a URL.

The styles, views, and dialogs may be parsed on the fly by the definition-parsing engine, as the definition-parsing engine consumes the style, dialog, and view definition information stored in the XML format file. This means that each style, view, and dialog returned by the methods may be unique for each reference to such item.

In one example embodiment operating with an XML dialog structure, the XML may be structured as follows:

```
<root>
  <styles>
    <!-- Style definitions -->
  </styles>
  <views>
    <!-- View definitions -->
  </views>
  <dialogs>
    <!-- Dialog definitions -->
  </dialogs>
</root>
```

In a further example embodiment, localization text may also be included in the XML dialog definition structure. For example:

```
<sampletext>
  <!-- Localization text, E.g.: -->
  <text key=”en_US:MyPackage:MyKey”>Sample English
  text.</text>
  <text key=”fr_FR:MyPackageMyKey”>Le sample text
  noi.</text>
</sampletext>
```

Styles.

The styles defined in the XML dialog definition may be used to define the visual characteristics of individual views, such as the font size, color, background color, and the like. For example, a single style can be defined that can set the font size, style, and text color for all static text fields in each dialog displayed in a user interface. Each dialog may then use that common style whenever it displays a static text field. If changes are to be made to update the style, then only one location may need to be updated.

In one example embodiment, styles can also extend other styles to provide further definition or changes of underlying styles. An example style for a dialog provided in the XML definition may include:

```
<style name=“sampleDialogStyle”>
  <colors>
    <color>0x000000</color>
    <color>0xffffff</color>
  </colors>
  <data>
    <round>50</round>
    <border>4</border>
  </data>
  <fonts>
    <font name=“Arial” size=“26” color=“0x000000”/>
  </fonts>
</style>
```

Views.

Views provide a tree of visual controllers and/or child views that define a tree of visual elements to display in a dialog. Some views in the view list may be used directly to define dialogs, while others may be used to define the cells in dialog lists, or the items in a drop down or menu list. Each view can be thought of as a complete set of visual controls that take up a rectangular space on the display, and can be referenced by other views, or by dialogs.

Views may also provide a layout and design for common elements, for example, for button views that can be used by other views. Views may also include background images, masks, and the like. An example view provided in the XML definition may be structured as follows:

```
<Rectangle name=“sampleView” controller=“Resize” padX=“12”
padY=“12” style=“sampleDialogStyle”>
  <TextField name=“sampleText” style=“sampleDialogStyle”
  text=“Hello world!”/>
</Rectangle>
```

As further detail, this example view includes the following Rectangle and Text fields:
sampleView—A top-level view <Rectangle> for this sample dialog which uses a Resize controller. This implies that this view will grow/shrink dynamically based on the sizes of its children. Because the contents of the dialog are not intended to be constrained or squeezed tight, some padding values (padX and padY) may be used to instruct resize controller to provide its contents with some additional space. The base primitive of this view may be a rectangle as specified by the <Rectangle> tag; and may use the sampleDialogStyle style as a reference for how to draw itself. Because this view uses the rectangle class, it will be looking at sampleDialogStyle specifically for color and data information.
sampleText—A child of the sampleView; this view will be the contents of the dialog. It is a <TextField> but also points to the sampleDialogStyle style. Unlike the rectangle primitive used in the parent view, a TextField will check its style specifically for font information. The text is defined at this level and will be drawn using the fonts described in sampleDialogStyle.

Dialog Definitions.

Dialog definitions may be used to define independent dialog boxes or like display UI windows (e.g., popup boxes) which can be displayed. In one embodiment, each dialog may reference a root “view” defined in the views list to describe the layout of the dialog. The dialog may import more views to define various list cells and other popup views that also appear in the dialog.

Thus, dialogs may refer to other cell views defined in the view list and in some embodiments may not define views themselves. This means that a single view in the view list may be used by several dialogs, and the actual layout of a dialog may be defined by the view that the dialog refers to. Dialogs reusing a view may override content, however, to be unique for their use. An example dialog provided in the XML definition may include:

<dialog name=“SampleDialog” view=“DialogView”/>

Controllers.

Various controllers may be implemented by views and styles, and thus dialogs may be provided in the XML definition, or imported by the Dynamic Layout Engine at runtime. For example, in one embodiment, the Dynamic Layout Engine may provide a series of controllers, such as “Resize”, “Button”, “CloseButton”, “Position”, “Scroll”, “List”, which each accept user-provided inputs and/or attributes to accomplish some specific controller action.

For example, a Resize controller may be configured to accept each of the following attributes for a display view, as it measures the size of children display views and resizes itself so that it is large enough to contain the children display views:
resizeWidths: Comma-separated list of paths to children that should have their width matched to the widest child.
resizeHeights: Comma-separated list of paths to children that should have their heights matched to the tallest child.
padX: The amount of padding on the x axis in pixels to pad between children and one of the edges.
padY: The amount of padding on the y axis in pixels to pad between children and one of the edges.
marginLeft: The amount of pixels on the left side to pad.
marginRight: The amount of pixels on the right side to pad.
marginTop: The amount of pixels on the top to pad.
marginBottom: The amount of pixels on the bottom to pad.
viewToPin: The view to pin to one of the eight cardinal edges of the view.
pinHorizontal: Which side on the x axis to pin a view
pinVertical: Which side on the y axis to pin a view
pinOffsetX: The amount of pixels offset from the pinned origin to offset on the x axis.
pinOffsetY: The amount of pixels offset from the pinned origin to offset on the y axis.

A variety of like attributes, including attributes that may not be directly used in connection with size or positioning, may also be specified in connection with controllers.

As is evident from the preceding examples, various types of dialogs or other user interface display views may be configured to be dynamically generated from a predefined style and view and may implement various controller elements that factor user interface layout design considerations such as sizing.

### Dynamic Layout Engine

In one embodiment, dynamic displays are implemented through a flow-based layout engine configured to accurately calculate the position and size of elements for display in a dialog. Thus, instead of each control in a dialog being assigned a fixed x,y and width,height, the dynamic layout engine traverses the view graph from the bottom up, measuring each view's children, and then scaling each view to fit the appropriate content.

One of the benefits of a flow-based layout system is that when the elements in a child view change size (e.g., because of localized text, or due to content changes), the surrounding dialog, including the parent or sibling views, will automatically scale and arrange themselves to properly fit the new content.

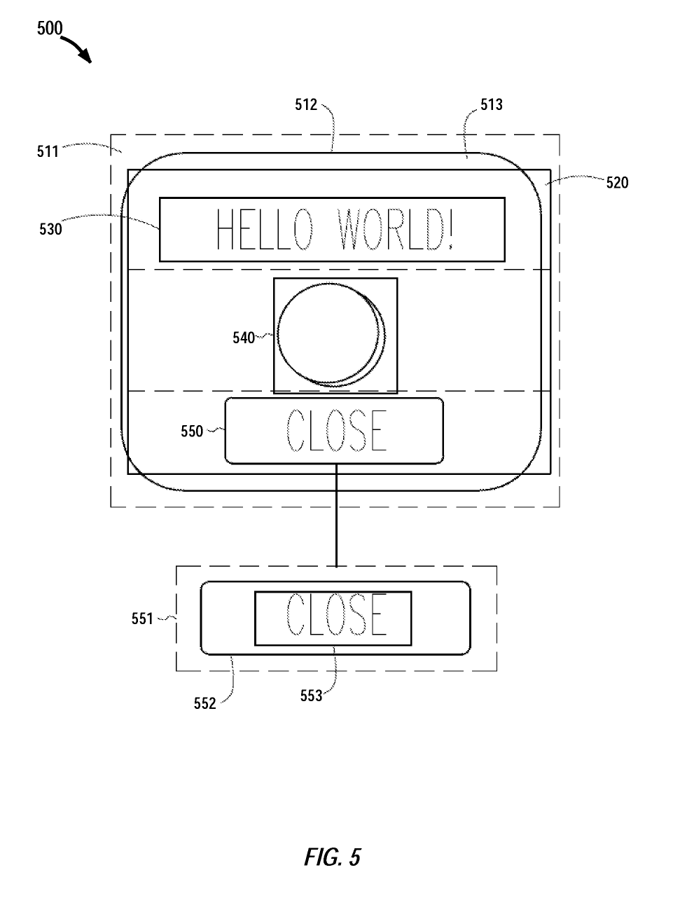

FIG. 5 is an interface diagram illustrating an example hierarchy of elements in a dynamic user interface display. As depicted, the dialog 500 is made up of the following views:

1. sampleView 511 (a mask controller) drawn using the sampleFilterStyle style (dependent on the next two views)

2. maskView 512 (the mask for the mask controller) drawn as a rectangle with the sampleDialogStyle style

3. imageView 513 (the image for the mask controller) drawn from a wood background, wood.png

4. samplePos 520 (position controller) formats the positions of all child views within the dialog (in this case, stacked and centered)

5. sampleText 530 (a text field, specifically resulting in display of “Hello World” text)

6. sampleImage 540 (an image displayed between the text and the button, as illustrated a coin image)

7. sampleClose 550 (an imported view of a button)

The imported view of the button contains its own hierarchy, specifically:

1. sampleCloseView 551 (CloseButton controller). This view controls the button state style changes for its base view (baseView)

2. baseView 552 (a Resize controller), configured to fit the size of its children. This is drawn initially with the sampleButtonStyle style, but changes styles to the styles defined in the parent CloseButton controller

3. CloseText 553 (a text field, specifically resulting in display of “Close”)

The following example XML definitions provided to the dynamic layout engine may be used to render the dialog 500:

```
<!-- The main view that describes our dialog -->
<Mask name=“sampleView” style=“sampleFilterStyle” padX=“12”
padY=“12” mask=“maskView” image=“imageView”>
  <Rectangle name=“maskView” style=“sampleDialogStyle”/>
  <Image name=“imageView” type=“tiled” src=“wood.jpg”/>
  <Position name=“samplePos” contentX=“1” align=“center”>
    <TextField name=“sampleText” style=“sampleDialogStyle”
text=“@Main:Hello”/>
    <Image name=“sampleImage” src=“coin.png”/>
    <import name=“sampleClose” view=“sampleCloseView”/>
  </Position>
</Mask>
```

In the definition above, the sampleClose view which results in display of Close button 550 is imported into the dialog view. The following example code is used to illustrate how the sampleClose view may be implemented for import to dialog 500:

```
<!-- Standalone button view that can be used by other views -->
<CloseButton name=“sampleCloseView” base=“baseView”
style=“sampleButtonStyle” styleOver=“sampleButtonOverStyle”
styleDown=“sampleButtonDownStyle”
styleDisabled=“sampleButtonDisabledStyle”>
      <Rectangle name=“baseView” controller=“Resize”
      style=“sampleButtonStyle” padX=“20”>
    <TextField name=“closeText” style=“sampleButtonStyle”
text=“Main:Close”/>
  </Rectangle>
</CloseButton>
```

Once the definitions are provided, the definitions may be imported into the dynamic layout engine for execution. For example, XML-format dialog display definitions may be imported into a Flash object using the following code, where XMLDialogParser is a class providing an instance for parsing the display definitions:

// Where EmbeddedDialogData is the class name of an embedded
XML definition resource
XMLDialogParser.getInstance( ) .parse(new EmbeddedDialogData) ;
// OR
// Where url is a string with the location of the XML
definition resource
XMLDialogParser.getInstance( ) .load(url);

Once the XML definitions are loaded, the dynamic layout engine may parse the definitions into an object that can be displayed. For example, the following client side code may be used to display a sample dialog:

var myDialog:DynamicDialog =
DefinitionParsingEngine.getInstance( ) .getDialog(“sampleView”) ;
addChild(myDialog.getView( )) ;

In this example, the variable myDialog is a DynamicDialog (a class that is an extension of a base controller display) and will contain all of the views and styles that were defined by the “sampleView” view in the XML definition file. Additionally, various attributes of the display dialogs can be changed at run-time. For example, text attributes can be changed to provide a localized text value in response to a detected localized language requirement.

Controllers and views may act on attributes that are passed to them and update in real-time. This means there may not be a difference between the behavior received from the dialog definition file or the programmer getting a reference to a view or controller and setting an attribute programmatically.

For example, the following attribute defined in the XML definition file:

<Position name=“holder” contentX=“3”/>

executes the same programmatically as:

var controller:PositionController=getChildController(“holder”); controller.setAttribute(“contentX”, 3);

The following describes additional features of dynamic data-driven displays that may be enabled in conjunction with use the previously described data definitions and definition parsing engine. However, some of these additional features may be implemented independently of the aforementioned components of the data definitions and definition parsing engine.

### Referential Rendering

In one example embodiment, various referential rendering features may be provided in connection with the XML-based definitions described herein. Referential rendering allows references to a view in a different location of the hierarchy. For example, a dialog can be built from a leaf element or a root element. Other views may be referenced and will automatically render themselves. This allows views to affect other views.

For example, XML may be parsed into a dictionary, allowing data to be referenced from throughout the DOM (document object model) structure. An XML element can then be parsed and the appropriate display constructed on screen. This is conducted by using a reference-based (not hierarchy-based) DOM structure.

Views may be defined in the XML-based definition as top-level objects that cross-reference each other. Thus, it is possible to build a dialog by saying that one object references another object, that references another object, and so on. Every view is a top-level object that can each reference each other.

Further, use of XML definitions in this fashion also enables recursive embedding of components within a display. This enables display view from external sources to be imported and reused, and various display components to be built outside a dialog but later used in the dialog. For example, a stylized progress bar is one potential application of such a display component that can be built outside a dialog.

Additionally, these techniques enable pairings of views (visual elements) with controllers (control elements). As previously suggested, the definitions may be provided for both visual elements and controller elements. For example, any of the following XML definitions may be used to describe a rectangle that can be resized based on the content of its children:

<view className=“Rectangle controller=“Resize”/>
OR
<Rectangle controller=“Resize”/>
OR
<Resize className=“Rectangle”/>

Visual elements have no behavior characteristics, whereas controller elements define the behavior of visual elements. One example of pairing includes a positioning grid controller that lays out content. Another example of paring includes a resize controller that resizes visual elements based on the number of children elements.

### Dynamic Layout Tools

In one example embodiment, various tools may be used to design and implement the dynamic display definitions and the various styles, views, positioning information, and other data placed within the definitions. The tools are provided with intelligence to understand how to output style and view definitions in XML, as well as provide direct API calls into an instance of a dialog for instant feedback on the changed attribute.

For example, a dialog generator tool may be configured to build and preview components and generate XML or like text definitions without requiring a user to manually add and edit XML tags. As another example, a dialog generator tool may be included with other integrated development environment (IDE) and testing tools.

### Language Adaptive Styles

Depending on what language is intended to be displayed, not only text but also styles of controls may be changed to display differently for the language. Although some existing user interfaces take localization into account and are capable of selecting text strings or graphics dynamically based on detected language, existing user interfaces do not automatically change the shape of the dialogs and change behavior based on localized content that may vary in its characteristics.

In one example embodiment, language adaptive dialogs may facilitate a variety of actions, including replacing markup, changing font size, changing to a different font, changing to different button shapes, and like visual effects. Thus, the displayed elements may be configured to dynamically resize as appropriate to look aesthetically pleasing and leave no unpleasant spaces or awkward gaps to fill the space.

### Resource-Intelligent Dialogs

In connection with the dialog definitions and definition parsing engine described herein, a user interface display system may adapt itself to locale or other relevant settings, to only download resources that it needs to draw for the locale. This enables optimum resource content management system patterning, and reduces the bandwidth required to download content in each session.

Various types of content may be selectively displayed based on localization settings. For example, if the system determines that a user only needs Spanish-language elements, it will only obtain Spanish-language content. The user will not be required to download a graphic-intensive German language splash screen, dialog, or view, for example. Thus, this will prevent the unnecessary download of any conditional graphic or textual content data provided based on locale.

This technique may also be used in conjunction with a content management system, to enable to only downloading or acquiring resources needed to display in a particular locale.

Interaction with Content Management System and APIs

The dynamic content views and definitions described herein may be integrated with a content management system (CMS) to provide text, graphics, animations, and other content. For example, dynamic content such as text or graphics may be referenced by definitions, and then rendered in a defined dialog or other user interface display. As the definition parsing engine determines the characteristics for the dialog, appropriate characteristics such as height, width, alignment, and the like can be determined based on the content. Thus, content may be retrieved from a CMS while all displays including such content automatically resizes or performs other suitable behavior.

In some embodiments, the user interface may directly integrate with the CMS at the server to show social game content without having to write any special code. The user interface may integrate with any backend service of the server, including services such as a social graph service which provides the graph of a player's friends and contacts, social game content services which provide information on in-game items such as virtual goods or items, social feed and messaging services which provide message between players, social game gifting services which provide services to allow players to send gifts to other players, social game requests services which provide services to allow players to request items or other help when playing a game, social game analytics services which report and/or provide information on individual or aggregate player interaction with the game, social game performance analysis services which provide information on operational performance and health of a game, social game experiment and AB testing services which provide AB and other testing for game features and components, game technical support services which provide customer support services for a game, social network abstraction layer services which abstract the interaction between the game and multiple social network services, virtual goods payment services which provide payment services for purchasing game items or goods, and the like.

In a further embodiment, the definitions may be used to specify or pull promotion-related data from a CMS, database, or other information system, for use and display within various dialogs and displays. In this fashion, this technique provides a mechanism similar to serving ads, while enabling the dialog to redraw itself according to specified styles based on the existence, type, or characteristics of a promotion.

For example, because of integration with promotions, a system can automatically inject promotional content into dialogs throughout a sequence of displays (for example, in a game). Promotions may also be scheduled in connection with content management sessions. Dialogs could be redrawn, for example, in light of inclusion of certain promotions or promotional-related activity.

The various display techniques described herein may also be used to integrate with third party application programming interfaces (APIs), such as showing a feed popup from a third party social networking system in connection with dialogs and other displays. The engine may be configured to pull data from third party APIs provided from a social network, for example, so that social network feed information can be displayed within the various dialogs and windows.

Further, integration with third party APIs such as social networking service APIs enables dialogs to be adaptive to social-related data. Likewise, dialogs and displays may consume APIs and other information services to be adaptive to back end data services, end user data, and social data. This provides a significant advantage over existing techniques, because such interaction may be handled in easily-editable markup definitions instead of needing implementation in code.

Interaction with Analytics and Tracking

The dynamic content views described herein also may be integrated with the CMS or like information systems to provide text, graphics, animations, and other content, while also providing tracking and analytics occurring as a result of the display of the dynamic content views. For example, global dialog system event handles may be used to allow analytics and other global systems to observe and report dialog popups, button clicks, and other user actions. In some embodiments, each dialog in a user interface is associated with a unique identifier to be referenced when tracking and analyzing data. As a user input is received at the user interface, the user interface may send a message to the game server indicating the unique identifier of the dialog and the user's activity (e.g., the user input) such that the user activity data may be used to perform analytics at the game server based on the user's behavior. In some embodiments, the analytics performed at the game server may include analyzing the user inputs to determine patterns in user behavior.

A dialog system may be configured to track all types of user interactions and respond accordingly. For example, some interactions that may be tracked include clicking buttons, cursor mouse-overs, and like user actions. In one embodiment, user interactions may be captured with use of a generic button controller that all buttons in the system implement. The generic button controller may notify the current top level dialog that a button was pressed or interacted with. From this event callback, the name of the dialog, button name, and instance of the dialog can be extracted and used to create a standard ontology for statistical tracking and like purposes. Other user interaction objects besides buttons may implement user interaction captures in similar fashion.

Additionally, certain alerts or messages may be provided as a result of detected user interactions with dialogs, or when unexpected behaviors occur with user interaction. This provides a simple way to measure interaction without having to build in specific user-monitoring logic into a Flash object, for example.

### Example Methods and System Configurations

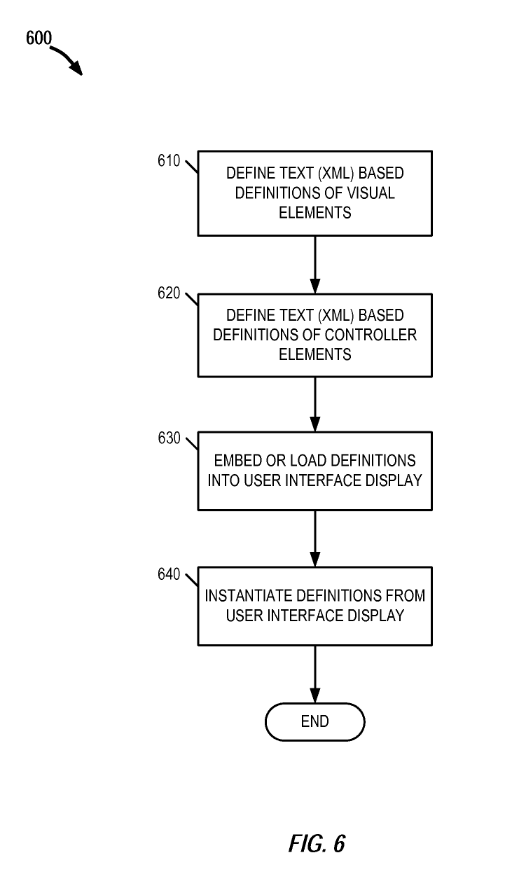

FIG. 6 is a flowchart showing an example method 600 of defining a design of a dynamic user interface display. As illustrated, method 600 includes a series of operations, which do not necessarily need to be performed in sequence.

In one example embodiment, the method 600 includes operations to define text (XML) based definitions of visual elements (operation 610) (e.g., using the display generator tools), define text (XML) based definitions of controller elements (operation 620) (e.g., using the display generator tools), embed or load definitions into a user interface display (operation 630) (e.g., using the display generator tools or the display definition module), and instantiate definitions from the user interface display (operation 640) (e.g., using the display generator tools or the dynamic layout engine).

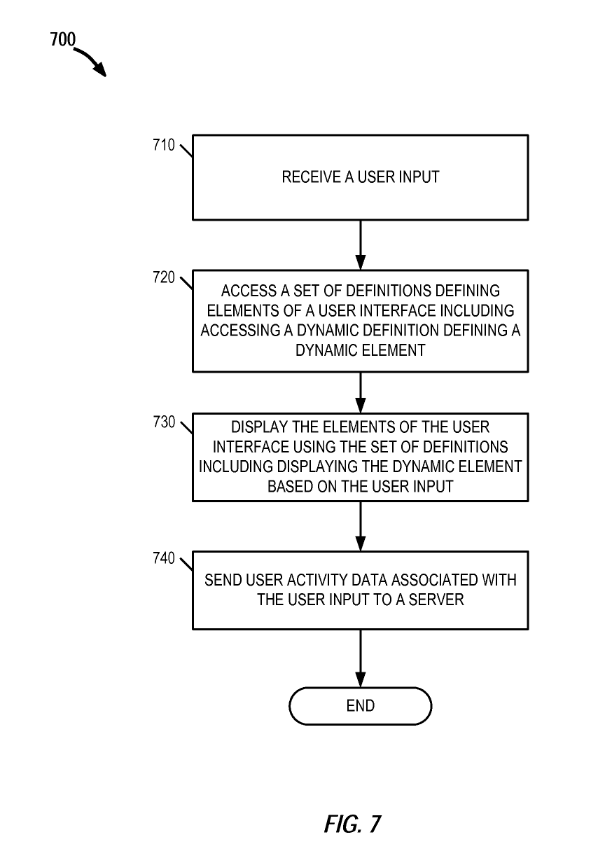

FIG. 7 is a flowchart showing an example method 700 of rendering a design of a dynamic user interface display. As illustrated, method 700 includes a series of operations, which do not necessarily need to be performed in sequence.

In operation 710, a hardware-implemented user input module may receive a user input from a user. The user input may be received at a client device of the user through a user interface on the client device.

In operation 720, the hardware-implemented display definition module may access a set of definitions defining elements of a user interface in response to receiving the user input. This may include accessing a dynamic definition defining a dynamic element of the user interface. The dynamic definition may define the dynamic element using any user attributes or user inputs received from the user.

In operation 730, the hardware-implemented dynamic layout engine may display the elements of the user interface using the set of definitions. This may include displaying the dynamic element of the user interface based on the user input received.

In operation 740, the hardware-implemented analytics module may send user activity data associated with the user input to a server, where the user activity data may be included in a user activity analysis performed by the server.

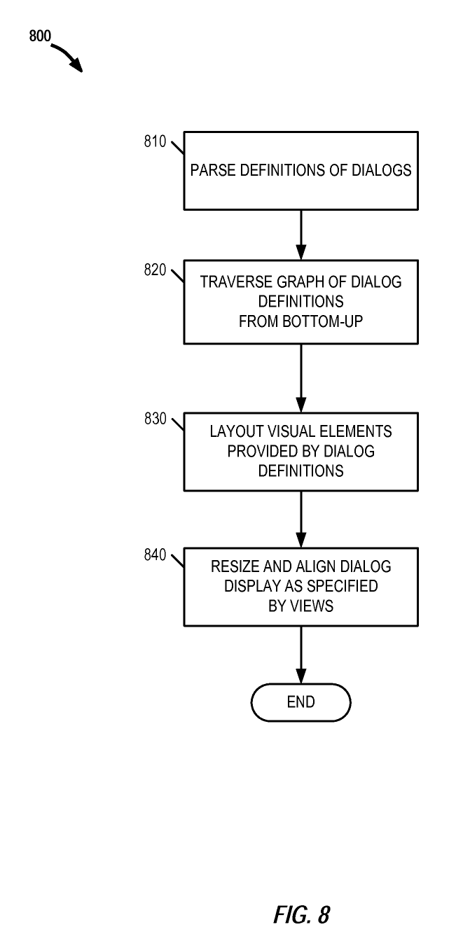

FIG. 8 is a flowchart showing an example method 800 of parsing definitions to render a design of a dynamic user interface display. As illustrated, method 800 includes a series of operations, which do not necessarily need to be performed in sequence.

In one example embodiment, the method 800 includes operations to parse the definitions of dialogs (operation 810), traverse a graph of dialog definitions from the bottom-up (operation 820), layout visual elements provided by dialog definitions (operation 830), and resize and align dialog display as specified by views (operation 840).

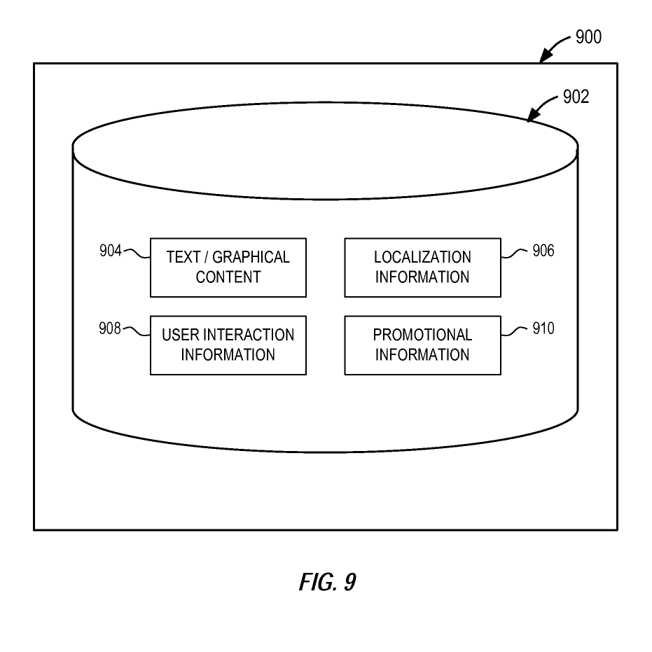

FIG. 9 is a block diagram illustrating an example database 900 to store information related to dynamic user interface displays. In some example embodiments, the database system 900 may correspond to the game networking system 108.2. In other example embodiments, the database system 900 may correspond to a separate computer system that may be accessed by the game networking system 108.2 via a computer network (e.g., the network 106). In still other example embodiments, the database system 900 may correspond to a content management system or other information system providing content in connection with the techniques described herein.

The database system 900 may include a database storage 902 that stores or manages information associated with the display and use of dynamic dialogs and user interface views. This may include, for example, text and graphical content 904 used in connection with dynamic dialog displays, localization information 906 used in connection with the selection of various content for dynamic dialog displays according to localization attributes, user interaction information 908 used in connection with user interactions with dynamic dialog displays, and promotional information 910 used in connection with control of promotional content in dynamic dialog displays.

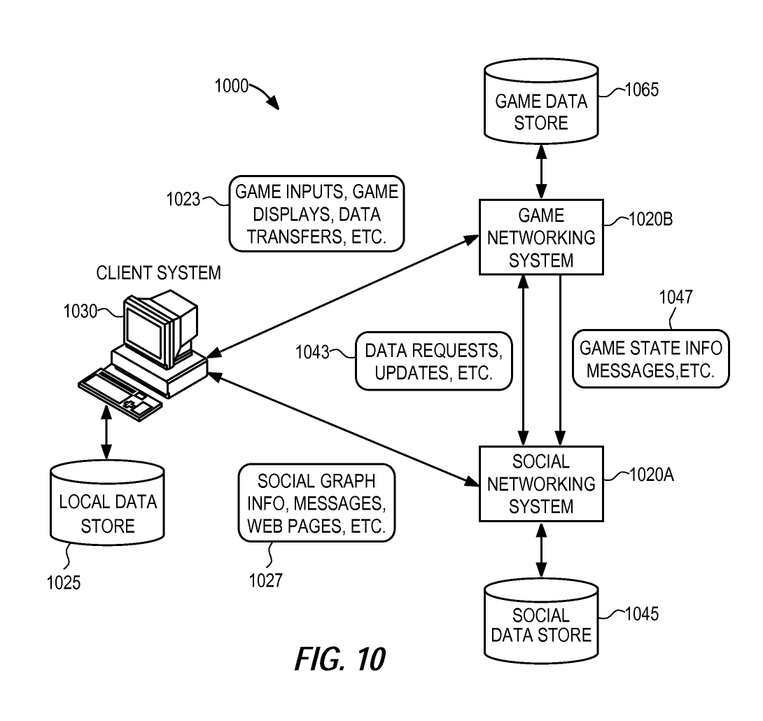

FIG. 10 is a diagrammatic representation of an example data flow between example components of the example system of FIG. 1. In particular embodiments, the system 1000 can include a client system 1030, a social networking system 1020A, and a game networking system 1020B. The components of system 1000 can be connected to each other in any suitable configuration, using any suitable type of connection. The components may be connected directly or over any suitable network. The client system 1030, the social networking system 1020A, and the game networking system 1020B can each have one or more corresponding data stores such as a local data store 1025, a social data store 1045, and a game data store 1065, respectively. The social networking system 1020A and the game networking system 1020B can also have one or more servers that can communicate with the client system 1030 over an appropriate network. The social networking system 1020A and the game networking system 1020B can have, for example, one or more internet servers for communicating with the client system 1030 via the Internet. Similarly, the social networking system 1020A and the game networking system 1020B can have one or more mobile servers for communicating with the client system 1030 via a mobile network (e.g., GSM, PCS, Wi-Fi, WPAN, etc.). In some embodiments, one server may be able to communicate with the client system 1030 over both the Internet and a mobile network. In other embodiments, separate servers can be used.

The client system 1030 can receive and transmit data 1023 to and from the game networking system 1020B. Data 1023 may include, for example, web pages, messages, game inputs, game displays, HTTP packets, data requests, transaction information, updates, and other suitable data. At some other time, or at the same time, the game networking system 1020B can communicate data 1043, 1047 (e.g., game state information, game system account information, page info, messages, data requests, updates, etc.) with other networking systems, such as the social networking system 1020B (e.g., Facebook, MySpace, Google+, etc.). The client system 1030 can also receive and transmit data 1027 to and from the social networking system 1020A. Data 1027 may include, for example, web pages, messages, social graph information, social network displays, HTTP packets, data requests, transaction information, updates, and other suitable data.

Communication between the client system 1030, the social networking system 1020A, and the game networking system 1020B can occur over any appropriate electronic communication medium or network using any suitable communications protocols. For example, the client system 1030, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

With a client-server environment in which the virtual games may run, one server system, such as the game networking system 1020B, may support multiple client systems 1030. At any given time, there may be multiple players at multiple client systems 1030 all playing the same virtual game. In practice, the number of players playing the same game at the same time may be very large. As the game progresses with each player, multiple players may provide different inputs to the virtual game at their respective client systems 1030, and multiple client systems 1030 may transmit multiple player inputs and/or game events to the game networking system 1020B for further processing. In addition, multiple client systems 1030 may transmit other types of application data to the game networking system 1020B.

In particular embodiments, a computed-implemented game may be a text-based or turn-based game implemented as a series of web pages that are generated after a player selects one or more actions to perform. The web pages may be displayed in a browser client executed on the client system 1030. As an example and not by way of limitation, a client application downloaded to the client system 1030 may operate to serve a set of web pages to a player. As another example and not by way of limitation, a computer-implemented game may be an animated or rendered game executable as a stand-alone application or within the context of a web page or other structured document. In particular embodiments, the computer-implemented game may be implemented using Flash-based technologies. As an example and not by way of limitation, a virtual game may be fully or partially implemented as a Shockwave Flash (SWF) object that is embedded in a web page and executable by a Flash media player plug-in. In particular embodiments, one or more described web pages may be associated with or accessed by the social networking system 1020a. This disclosure contemplates using any suitable application for the retrieval and rendering of structured documents hosted by any suitable network-addressable resource or website.

In particular embodiments, one or more objects of the virtual game may be represented as a Flash object. Flash may manipulate vector and raster graphics, and supports bidirectional streaming of audio and video. “Flash” may mean the authoring environment, the player, or the application files. In particular embodiments, the client system 1030 may include a Flash client. The Flash client may be configured to receive and run Flash application or game object code from any suitable networking system (such as, for example, the social networking system 1020A or the game networking system 1020B). In particular embodiments, the Flash client may be run in a browser client executed on the client system 1030. A player can interact with Flash objects using the client system 1030 and the Flash client. The Flash objects can represent a variety of in-game objects. Thus, the player may perform various in-game actions on various in-game objects by making various changes and updates to the associated Flash objects.

In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure describes performing any suitable in-game action by interacting with any suitable Flash object. In particular embodiments, when the player makes a change to a Flash object representing an in-game object, the client-executed game logic may update one or more game state parameters associated with the in-game object.

To ensure synchronization between the Flash object shown to the player at the client system 1030, the Flash client may send the events that caused the game state changes to the in-game object to the game networking system 1020B. However, to expedite the processing and hence the speed of the overall gaming experience, the Flash client may collect a batch of some number of events or updates into a batch file. The number of events or updates may be determined by the Flash client dynamically or determined by the game networking system 1020B based on server loads or other factors. For example, the client system 1030 may send a batch file to the game networking system 1020B whenever 50 updates have been collected or after a threshold period of time, such as every minute.

In particular embodiments, when the player 102 plays the virtual game on the client system 1030, the game networking system 1020B may serialize all the game-related data, including, for example and without limitation, game states, game events, user inputs, for this particular user and this particular game into a binary large object (BLOB) and store the BLOB in a database. The BLOB may be associated with an identifier that indicates that the BLOB contains the serialized game-related data for a particular player and a particular virtual game. In particular embodiments, while a player is not playing the virtual game, the corresponding BLOB may be stored in the database. This enables a player to stop playing the game at any time without losing the current state of the game the player is in. When a player resumes playing the game next time, game networking system 1020B may retrieve the corresponding BLOB from the database to determine the most-recent values of the game-related data. In particular embodiments, while a player is playing the virtual game, the game networking system 1020B may also load the corresponding BLOB into a memory cache so that the game system may have faster access to the BLOB and the game-related data contained therein.

In particular embodiments, one or more described web pages may be associated with a networking system or networking service. However, alternate embodiments may have application to the retrieval and rendering of structured documents hosted by any type of network addressable resource or website. Additionally, as used herein, a user may be an individual, a group, or an entity (such as a business or third-party application).

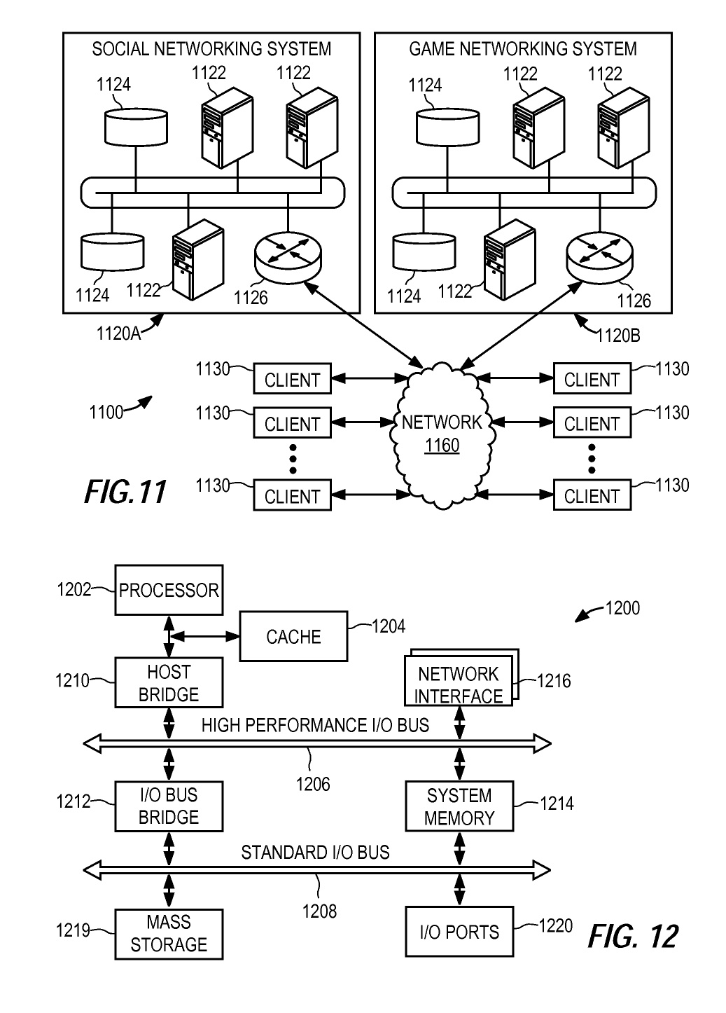

Particular embodiments may operate in a wide area network environment, such as the Internet, including multiple network addressable systems. FIG. 11 is a schematic diagram showing an example network environment 1100, in which various example embodiments may operate. The network environment 1100 may include a network cloud 1160 that generally represents one or more interconnected networks, over which the systems and hosts described herein can communicate. The network cloud 1160 may include packet-based wide area networks (such as the Internet), private networks, wireless networks, satellite networks, cellular networks, paging networks, and the like. As FIG. 11 illustrates, particular embodiments may operate in the network environment 1100 comprising one or more networking systems, such as a social networking system 1120A, a game networking system 1120B, and one or more client systems 1130. The components of the social networking system 1120A and the game networking system 1120B operate analogously; as such, hereinafter they may be referred to simply as the networking system 1120. The client systems 1130 are operably connected to the network environment 1100 via a network service provider, a wireless carrier, or any other suitable means.

The networking system 1120 is a network addressable system that, in various example embodiments, comprises one or more physical servers 1122 and data stores 1124. The one or more physical servers 1122 are operably connected to network cloud 1160 via, by way of example, a set of routers and/or networking switches 1126. In an example embodiment, the functionality hosted by the one or more physical servers 1122 may include web or HTTP servers, FTP servers, as well as, without limitation, web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

The network environment 1100 may include physical servers 1122 that may host functionality directed to the operations of the networking system 1120. Hereinafter the servers 1122 may be referred to as the server 1122, although the server 1122 may include numerous servers hosting, for example, the networking system 1120, as well as other content distribution servers, data stores, and databases. The network environment 1100 may also include a data store 1124 that may store content and data relating to, and enabling, operation of the networking system 1120 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, the data store 1124 corresponds to one or more of a variety of separate and integrated databases, such as relational databases and object-oriented databases, that maintain information as an integrated collection of logically related records or files stored on one or more physical systems. Structurally, data store 1124 may generally include one or more of a large class of data storage and management systems. In particular embodiments, the data store 1124 may be implemented by any suitable physical system(s) including components, such as one or more database servers, mass storage media, media library systems, storage area networks, data storage clouds, and the like. In one example embodiment, data store 1124 includes one or more servers, databases (e.g., MySQL), and/or data warehouses. The data store 1124 may include data associated with different networking system 1120 users and/or client systems 1130.

The client system 1130 is generally a computer or computing device including functionality for communicating (e.g., remotely) over a computer network. The client system 1130 may be a desktop computer, laptop computer, personal digital assistant (PDA), in- or out-of-car navigation system, smart phone or other cellular or mobile phone, or mobile gaming device, among other suitable computing devices. The client system 1130 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of the client system 1130 to enter addresses of specific network resources to be retrieved, such as resources hosted by the networking system 1120. These addresses can be URLs and the like. In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page.

A web page or resource embedded within a web page, which may itself include multiple embedded resources, may include data records, such as plain textual information, or more complex digitally-encoded multimedia content, such as software programs or other code objects, graphics, images, audio signals, videos, and so forth. One prevalent markup language for creating web pages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a web page may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at the client system 1130 desires to view a particular web page (hereinafter also referred to as target structured document) hosted by the networking system 1120, the user's web browser, or other document rendering engine or suitable client application, formulates and transmits a request to the networking system 1120. The request generally includes a URL or other document identifier as well as metadata or other information. By way of example, the request may include information identifying the user, such as a user ID, as well as information identifying or characterizing the web browser or operating system running on the user's client system 1130. The request may also include location information identifying a geographic location of the user's client system 1130 or a logical network location of the user's client system 1130. The request may also include a timestamp identifying when the request was transmitted.

Although the example network environment 1100 described above and illustrated in FIG. 11 is described with respect to the social networking system 1120A and the game networking system 1120B, this disclosure encompasses any suitable network environment using any suitable systems. As an example and not by way of limitation, the network environment may include online media systems, online reviewing systems, online search engines, online advertising systems, or any combination of two or more such systems.

FIG. 12 is a block diagram illustrating an example computing system architecture, which may be used to implement one or more of the methodologies described herein. In one embodiment, a hardware system 1200 comprises a processor 1202, a cache memory 1204, and one or more executable modules and drivers, stored on a tangible computer-readable medium, directed to the functions described herein. Additionally, hardware system 1200 may include a high performance input/output (I/O) bus 1206 and a standard I/O bus 1208. A host bridge 1210 may couple the processor 1202 to a high performance I/O bus 1206, whereas an I/O bus bridge 1212 couples the two buses 1206 and 1208 to each other. A system memory 1214 and one or more network/communication interfaces 1216 may couple to the bus 1206. The hardware system 1200 may further include video memory (not shown) and a display device coupled to the video memory. A mass storage 1218 and I/O ports 1220 may couple to the bus 1208. The hardware system 1200 may optionally include a keyboard, a pointing device, and a display device (not shown) coupled to the bus 1208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1200 are described in greater detail below. In particular, the network interface 1216 provides communication between the hardware system 1200 and any of a wide range of networks, such as an Ethernet (e.g., IEEE 802.3) network, a backplane, etc. The mass storage 1218 provides permanent storage for the data and programming instructions to perform the above-described functions implemented in the servers 1222 of FIG. 12, whereas the system memory 1214 (e.g., DRAM) provides temporary storage for the data and programming instructions when executed by the processor 1202. The I/O ports 1220 are one or more serial and/or parallel communication ports that provide communication between additional peripheral devices, which may be coupled to the hardware system 1200.

The hardware system 1200 may include a variety of system architectures, and various components of the hardware system 1200 may be rearranged. For example, the cache memory 1204 may be on-chip with the processor 1202. Alternatively, the cache memory 1204 and the processor 1202 may be packed together as a “processor module,” with the processor 1202 being referred to as the “processor core.” Furthermore, certain embodiments of the present disclosure may not include all of the above components. For example, the peripheral devices shown coupled to the standard I/O bus 1208 may couple to the high performance I/O bus 1206. In addition, in some embodiments, only a single bus may exist, with the components of the hardware system 1200 being coupled to the single bus. Furthermore, the hardware system 1200 may include additional components, such as additional processors, storage devices, or memories.

An operating system manages and controls the operation of the hardware system 1200, including the input and output of data to and from software applications (not shown). The operating system provides an interface between the software applications being executed on the hardware system 1200 and the hardware components of the hardware system 1200. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably, and additionally may refer to a custom or generalized API on a device, such as a mobile device (e.g., cellular phone, smart phone, personal GPS, personal digital assistance, personal gaming device, etc.), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

1. (canceled)

2. A computer-implemented method for comprising:
detecting, at a client device, a geographic location associated with the client device;
determining, at the client device, a localized language requirement associated with the geographic location;
receiving, at the client device from a networking system computer, content for presentation on a display of the client device, the content being associated with the localized language requirement and the geographic location;
accessing a set of definitions defining elements of a user interface in response to receiving the content, wherein accessing the set of definitions further comprises accessing a dynamic definition for resizing a dynamic element of the user interface, the dynamic definition resizing the dynamic element using the content; and
displaying the elements of the user interface using the set of definitions including displaying a resized dynamic element of the user interface based on the content and the localized language requirement.

3. The method of claim 2 further comprising, communicating from the client device to the networking system computer, the localized language requirement; and
wherein, based on the localized language requirement communicated to the networking system computer, the content comprises only language content for a language associated with the localized language requirement.

4. The method of claim 2, wherein accessing the dynamic definition for resizing the dynamic element of the user interface comprises:
automatically calculating dimensions for dialog in the content through a text field's container margins, padding, and maximum width and height.

5. The method of claim 2, wherein accessing the dynamic definition for resizing the dynamic element of the user interface comprises:
calculating, using the dynamic definition, an updated position for the resized dynamic element on the user interface based on the content associated with the geographic location.

6. The method of claim 2, wherein accessing the dynamic definition for resizing the dynamic element of the user interface comprises:
calculating, using the dynamic definition, a modified size of the dynamic element on the user interface based on the content.

7. The method of claim 2 wherein the set of definitions comprises definitions for a set of visual elements and for a set of controller elements, wherein the set of visual elements are standardized for display across multiple display interfaces and wherein the set of controller elements implement display behaviors independent of the content.

8. The method of claim 7 wherein a first controller element of the set of controller elements comprises a resize controller that resize associated elements based on a number of child objects presented inside each of the associated elements as presented in the user interface.

9. The method of claim 8 wherein the resize controller is configured to accept one or more attribute values for a display view as the resize controller measures a size of child display views and resizes to manage containment of the child display views.

10. The method of claim 9 wherein the one or more attribute values comprises at least one comma-separated list of paths to children to have widths matched to a widest child width.

11. The method of claim 10 wherein the one or more attribute values comprises at least one pad value identifying an amount of padding in pixels to pad between children and edges.

12. The method of claim 2 wherein the content comprises a set of data-dependent graphics elements.

13. The method of claim 2 wherein the content comprises localized text.

14. The method of claim 2, wherein accessing a dynamic definition for resizing the dynamic element of the user interface comprises accessing a dynamic layout engine configured to traverse a view graph associated with the content from a bottom up, measuring children for each view associated with the content and scaling each view for the content.

15. The method of claim 2 wherein accessing the dynamic definition for resizing the dynamic element of the user inter face comprises accessing a set of definitions parsed into a dictionary as referenced within a document object model structure of the content for referential rendering of the content.

16. The method of claim 2 wherein accessing the dynamic definition for resizing the dynamic element of the user inter face comprises accessing a set of font, button shape, and visual effect elements associated with the localized language requirement.

17. A non-transitory computer-readable storage medium storing instructions which, when executed by one or more processors, cause the one or more processors of a client device to perform operations, comprising:
detecting, at the client device, a geographic location associated with the client device;
determining, at the client device, a localized language requirement associated with the geographic location;
receiving, at the client device from a networking system computer, content for presentation on a display of the client device, the content being associated with the localized language requirement and the geographic location;
accessing a set of definitions defining elements of a user interface in response to receiving the content, wherein accessing the set of definitions further comprises accessing a dynamic definition for resizing a dynamic element of the user interface, the dynamic definition resizing the dynamic element using the content; and
displaying the elements of the user interface using the set of definitions including displaying a resized dynamic element of the user interface based on the content and the localized language requirement.

18. The non-transitory computer-readable storage medium of claim 10, wherein the instructions cause the one or more processors to perform further operations, comprising:
accessing, using the user interface on the client device, a content management system on the server, the elements of the user interface being associated with a computer-implemented game of the server, the content management system storing content associated with the computer-implemented game.

19. A system, comprising:
a hardware-implemented detection module configured to detect a geographic location of a client device and to determine, at the client device, a localized language requirement associated with the geographic location, wherein based on the localized language requirement communicated to the networking system computer, the content comprises only content for a language associated with the localized language requirement.
a hardware-implemented input module configured to receive, at the client device from a networking system computer, content for presentation on a display of the client device, the content being associated with the localized language requirement and the geographic location;
a hardware-implemented display definition module configured to access a set of definitions defining elements of a user interface in response to receiving the content, wherein accessing the set of definitions further comprises accessing a dynamic definition for resizing a dynamic element of the user interface, the dynamic definition resizing the dynamic element using the content; and
a hardware-implemented dynamic layout engine configured to display the elements of the user interface using the set of definitions including displaying a resized dynamic element of the user interface based on the content and the localized language requirement.

20. The system of claim 19 further comprising a hardware-implemented game engine configured to access a content management system on the server, the elements of the user interface being associated with a computer-implemented game of the server, the content management system storing content associated with the computer-implemented game;
wherein the display definition module is further configured to automatically calculate dimensions for dialog in the content through a text field's container margins, padding, and maximum width and height.

21. The system of claim 19 wherein the set of definitions comprises definitions for a set of visual elements and for a set of controller elements, wherein the set of visual elements are standardized for display across multiple display interfaces and wherein the set of controller elements implement display behaviors independent of the content;
wherein a first controller element of the set of controller elements comprises a resize controller that resize associated elements based on a number of child objects presented inside each of the associated elements as presented in the user interface; and
wherein the resize controller is configured to accept one or more attribute values for a display view as the resize controller measures a size of child display views and resizes to manage containment of the child display views.
